(19) United States
(12) Patent Application Publication
(10) Pub. No.: US 2003/0018747 A1
(43) Pub. Date: Jan. 23, 2003

(54) Web presence detector

(76) Inventors: Bjarne Geir Herland, Bergen (NO); Alexey Goloshubin, Bergen (NO)

Correspondence Address: Davidson, Davidson & Kappel, LLC, 14th Floor, 485 Seventh Avenue, New York, NY, 10018, US

(21) Appl. No.: 10/198,518

(22) Filed: Jul. 18, 2002

Related U.S. Application Data
(60) Provisional application No. 60/306,884, filed on Jul. 20, 2001.

(51) Int. Cl. G06F 15/16

(52) U.S. Cl. 709/218; 709/228

(57) ABSTRACT

A system and method for detecting one or more user presences in a virtual location is provided which includes the steps of directing a web browser to enter a virtual location, the browser associated with a first user, communicating the virtual location of the first user from the browser to a tracking server, and entering the first user and the virtual location of the first user, as a first user presence, into a database of user presences which is associated with the tracking server. The method further includes the steps of searching the database for any user presences in the virtual location of the first user, transmitting the user presences to the browser of the first user, and communicating the user presences to the first user through the browser.

This application claims priority from U.S. Provisional Application Serial No. 60/306,884, filed Jul. 20, 2001, the entire disclosure of which is hereby incorporated by reference.

### BACKGROUND

The Internet, a network connecting many computer networks and based on a common addressing system and communications protocol called TCP/IP (Transmission Control Protocol/Internet Protocol), has revolutionized the computer and communications world like nothing before. From its creation, it grew rapidly beyond its largely academic origin into an increasingly commercial and popular medium.

By the mid-1990s the internet connected millions of computers throughout the world. Many commercial computer network and data services also provided at least indirect connection to the Internet.

The original uses of the Internet were electronic mail (commonly called “E-mail”), file transfer (using FTP, or file transfer protocol), bulletin boards and newsgroups, and remote computer access (telnet). The World Wide Web, which enables simple and intuitive navigation of Internet sites through a graphical interface, expanded dramatically during the 1990s to become the most important component of the Internet.

The Internet had its origin in a U.S. Department of Defense program called ARPANET Advanced Research Projects Agency Network), established in 1969 to provide a secure and survivable communications network for organizations engaged in defense-related research. Researchers and academics in other fields began to make use of the network, and at length the National Science Foundation (NSF), which had created a similar and parallel network called NSFNet, took over much of the TCP/IP technology from ARPANET and established a distributed network of networks capable of handling far greater traffic. NSF continues to maintain the backbone of the network (which carries data at a rate of 45 million bits per second), but Internet protocol development is governed by the Internet Architecture Board, and the InterNIC (Internet Network Information Center) administers the naming of computers and networks.

Amateur radio, cable television wires, spread spectrum radio, satellite, and fibre optics all have been used to deliver Internet services. Networked games, networked monetary transactions, and virtual museums are among applications being developed that both extend the network's utility and test the limits of its technology.

The World Wide Web (WWW) is the leading information retrieval service of the Internet (the worldwide computer network). The Web gives users access to a vast array of documents that are connected to each other by means of electronic links (e.g., hypertext.) Hypertext allows the user to select an object (e.g., a word or icon) and use it to access other documents that contain additional information pertaining to that word. The Web operates within the Internet's basic client-server format. A server is a computer programs that stores and transmits data (such as documents, programs, images, etc.) to other computers on the network when asked to, while clients are programs that request data from a server as the user asks for them. Browser software allows users to view the retrieved data.

The development of the World Wide Web began in 1989 by Tim Berners-Lee and his colleagues at CERN, an international scientific organization based in Geneva, Switzerland. They created a protocol, HyperText Transfer Protocol (HTTP), which standardized communication between servers and clients. Their text-based Web browser was made available for general release in January 1992. The World Wide Web gained rapid acceptance with the creation of a Web browser called Mosaic, which was developed in the United States at the National Center for Supercomputing Applications at the University of Illinois. Mosaic allowed people using the Web to use a “point-and-click” GUI. A wide variety of web browsers are currently available including Netscape Communication Corp's Netscape Navigator, Microsoft's Internet Explorer browser, and Wind River System's Ice Storm browser.

### SUMMARY

In accordance with a first embodiment of the present invention, a method for detecting one or more user presences in a virtual location is provided which includes the steps of directing a web browser (which is associated with a first user) to enter a virtual location, communicating the virtual location of the first user from the browser to a tracking server, and entering the first user and the virtual location of the first user, as a first user presence, into a database of user presences which is associated with the tracking server. The method further includes the steps of searching the database for any user presences in the virtual location of the first user, transmitting the user presences to the browser of the first user, and communicating the user presences to the first user through the browser.

In accordance with a second embodiment of the present invention, a system is provided for identifying user presences in a virtual location. The system includes a tracking server and a plurality of web browsers. The plurality of web browsers execute on a plurality of processors, and each browser, upon entering a virtual location, communicates the virtual location to the tracking server. The tracking server is configured to receive a virtual location from a respective one of the browsers, and to enter a user of the respective one of the browsers and the virtual location into a database of user presences. The tracking server is also configured to search the database for any user presences in the virtual location, and to communicate the user presences to the respective one of the browsers.

In accordance with a third embodiment of the present invention, a system for identifying user presences in a virtual location is provided which includes a database and a tracking server. The database associates each of a plurality of users with a corresponding current virtual location displayed on a corresponding web browser of said each user. The tracking server is coupled to the database, and is configured to receive a new virtual location from a respective first browser of the plurality of browsers, and to associate a respective first user of the first browser with the new virtual location in the database. The tracking server is also configured to search the database for any other ones of the plurality of users that are associated with the new virtual location, and to communicate the associated users to the first browser.

In accordance with a fourth embodiment of the present invention, a system for identifying user presences in a virtual location is provided which includes a web browser. The web browser is configured to send, to a tracking server, a virtual location of a first user of a plurality of users; to receive, from the tracking server, an identification of any other user of the plurality of users that are associated with the virtual location; and to communicate the associated users to the first user.

In accordance with a fifth embodiment of the present invention, a system for identifying user presences in a virtual location is provided which includes a plurality of tracking servers arranged in a network and a plurality of web browsers which execute on a plurality of processors. Each tracking server has associated therewith a database of user presences. Each browser, upon entering a virtual location, communicates the virtual location to a first tracking server of the plurality of tracking servers. The first tracking server, in turn, is configured to receive a virtual location from a respective one of the browsers, and to enter a user of the respective one of the browsers and the virtual location into the database of user presences associated with the first tracking server. The first tracking server is also configured to search the associated database to identify any user presences in the virtual location and to query at least one other tracking server of the plurality tracking servers for any user presences in the virtual location of the first user. Each of the at least one other tracking servers is configured to search its associated database to identify any user presences in the virtual location of the first user. In addition, at least one of the first tracking server and the at least one other tracking server is configured to communicate the identified user presences to the user via the respective one of the browsers.

In accordance with a sixth embodiment of the present invention, computer readable media are provided, which have stored thereon, computer executable process steps operable to control a computer to receive a virtual location of a first user from a web browser, enter the first user and the virtual location of the first user, as a first user presence, into a database of user presences, search the database for any user presences in the virtual location of the first user, and transmit the user presences to the browser of the first user.

In accordance with still further embodiments of the present invention, computer readable media are provided, which, have stored, thereon, computer executable process steps operable to control the processors and tracking servers of the first, second, third, fourth, and fifth embodiments.

### BRIEF DESCRIPTION OF THE DRAWINGS

FIG. 1(a) illustrates a first embodiment of a web presence detector in accordance with a first embodiment of the present invention.

FIG. 1(b) illustrates an illustrative browser display for the embodiment of FIG. 1(a).

FIG. 1(c) shows a flow chart for the embodiment of FIG. 1(a).

FIG. 2 shows a flow chart of a second embodiment of the web presence detector in which a browser notifies a domain of a web page being entered of the presence of a user.

FIG. 3(a) illustrates a third embodiment of the present invention, wherein a plurality of tracking servers are arranged in a hierarchal network.

FIG. 3(b) shows a flowchart for the third embodiment of FIG. 3(a).

FIG. 4(a) illustrates a fourth embodiment of the present invention, wherein a plurality of tracking servers are arranged in a distributive network.

FIG. 4(b) shows a flowchart for the third embodiment of FIG. 4(a).

### DETAILED DESCRIPTION OF THE PREFERRED EMBODIMENTS

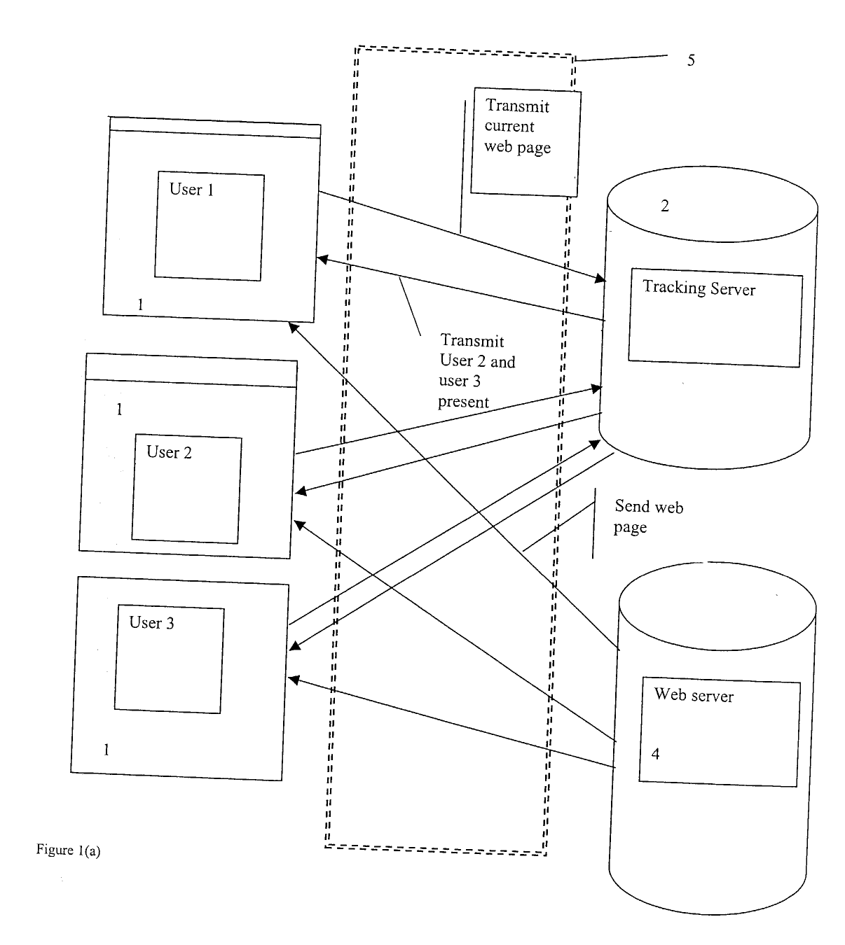

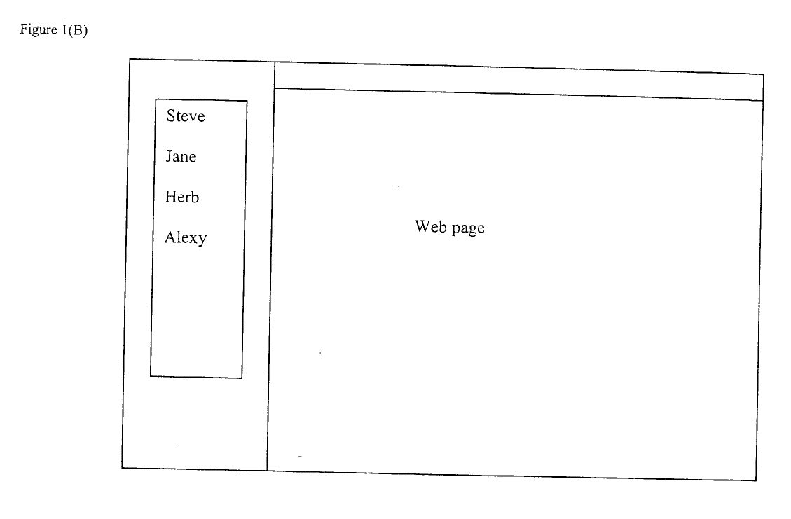

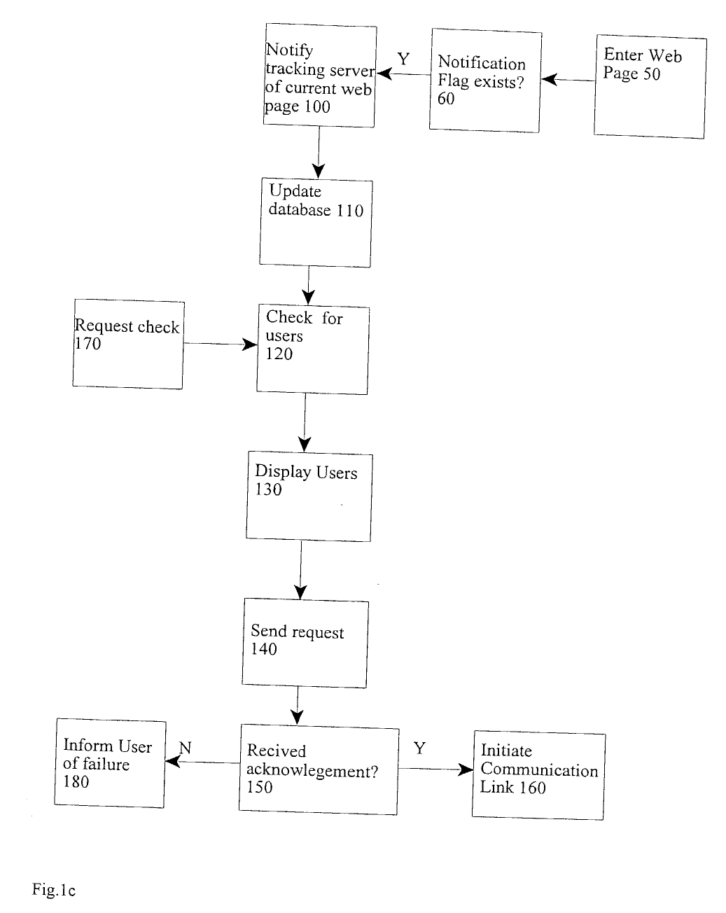

FIG. 1(a) illustrates a first embodiment of a web presence detector in accordance with the present invention, FIG. 1(b) illustrates an illustrative browser display for the embodiment of FIG. 1(a), and FIG. 1(c) shows a flow chart for the embodiment of FIG. 1(a).

Referring to FIG. 1(a), the system includes an application running on a browser 1 and a tracking server 2 which communicates with the browser 1 over the a network 5 (e.g., the Internet or a corporate intranet). As a user surfs the web using the browser 1, the browser 1 notifies the tracking server of what web page (on a web server 4) it is currently viewing. The tracking server thereby maintains a database indicating which users running the browser 1 are viewing which web pages on the web. As an example, upon receiving an indication that a user 1 (using an instance of browser 1) is on a particular web page, the tracking server 2 searches it database for any other users who are currently on the web page. If other users 2 and 3 (using other instances of the browser 1) are on the web page, it notifies user 1's browser 1 of those users. The users 2 and 3 can then be identified on user l's display screen, for example, in a separate pane. The target server 2 could be configured to maintain only each user's current web page to provide increased security. Alternatively, the target server could be configured to maintain a log of all web pages visited by the user. The choice could be made at either the user or system level, depending on the application. The users 2-6 could be identified in a variety of ways, for example, by name, e-mail address, 2D image, 3D image, etc.

FIG. 1(c) provides an illustrative flow chart for the embodiment of FIG. 1(a). As described above, the web presence detector in accordance with the present invention makes use of both a browser 1 (or a plug-in to a browser) and a tracking server 2. The browser 1 allows a first user to view a web page on a web server 4, while the tracking server 2 records the browsers whereabouts. When the browser 1, which user 1 directs, enters the web page (step 50), the browser 1 notifies (e.g., by use of a packet, datagram, or other system) the tracking server that the first user has entered the web page (step 100). In certain embodiments, the notification is via a TCP/IP packet or UDP packet. The browser may have the address of the tracking server hard-coded therein. In another embodiment, when the browser initializes, the browser may query a central source and thereby obtain the address of the tracking server 2.

In certain embodiments of the present invention, the web page contains a notification flag which, in effect, allows the owner or administrator of the web page to “opt out” of the tracking function. In this regard, the owner of the web page may add or remove (e.g., toggle) the notification flag. In these embodiments, if the web page includes the notification flag (step 60), the browser notifies the tracking server (step 100) of the web page. However, if there is no notification flag, the browser 1 does not notify the tracking server 2 of its presence on the web page. The functionality implementing the notification step (step 100), and the notification flag checking step (step 60) when present, can be hard-coded into the browser 1.

In any event, the tracking server 2 uses the notification received from the browser 1 to update a database of which users are viewing which web pages (step 110). As described above, the tracking server may maintain a log of prior web pages that the user has visited.

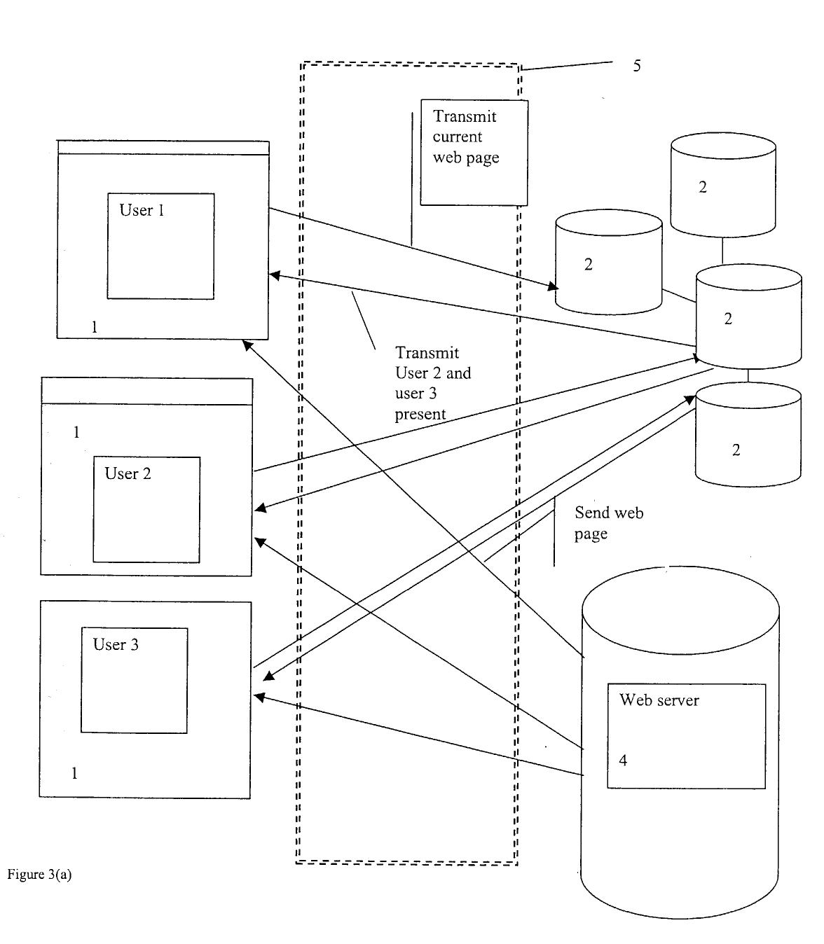

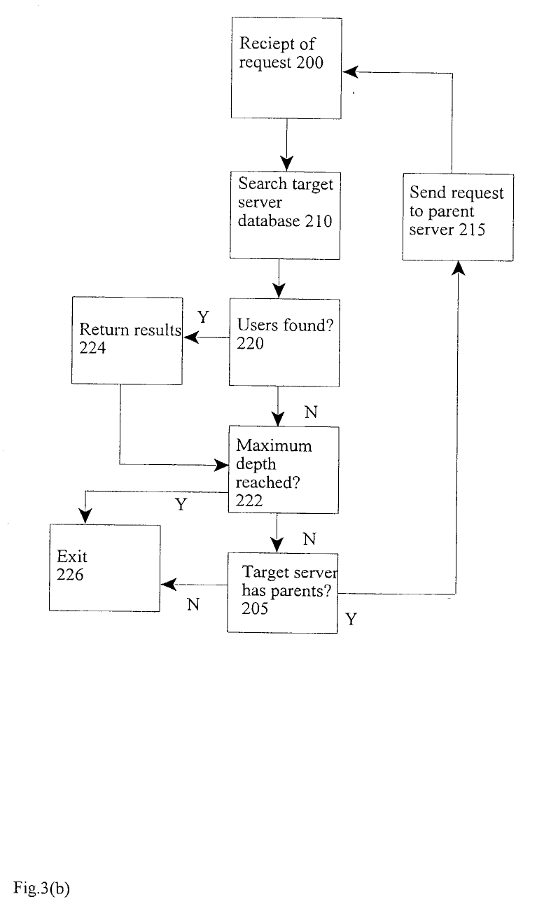

Then, the tracking server performs a check to determine if any other users are currently viewing the web page (step 120). The check may simply be querying the database associated with the tracking sever 2 for users in the current web page. However, the check can also be performed by more complicated schemes, which allow for more versatile network arrangements, as shown in FIGS. 3,4. It should be appreciated that in the embodiment of FIG. 1(a-c), the tracking server 2 will only identify (in step 120) users who are viewing the web page via an instance of browser 1 (i.e., a browser which is implementing the notification function of step 100).

The identified users, which may include user 1, are then communicated with and displayed to the user 1 (step 130) via user l's browser 1. The communication can, for example, be from the tracking server to the browser. The communication can be via a packet, datagram or other system. The communication can also use network protocols, such as TCP/IP or UDP. This approach provides the advantage of allowing all of the functionality implementing the web presence detector to reside within the browser 1 (or elsewhere on the computer implementing the browser 1) and the tracking server 2. No customization of the web server is required. In other embodiments of the present invention, the communication may be made from the tracking server to the domain of the web page and then from the domain to the web page to the browser. In still other embodiments, the communication can be made from the tracking server to the domain of the first user (e.g., a LAN server) and then from the domain of the user to the browser of the user (e.g. user 1). The display of the users on the web page, which may include user 1, can be a textual representation of the user's identity, for example, an e-mail address, a name, or the name of a particular machine. However, the users can also be identified by an image (2-D or 3-D), or a graphical symbol, for example, an icon. The textual representation, image, and graphical symbol are not mutually exclusive, thus, a textual representation along with an image of the user can be displayed. Moreover, the users can be displayed on the web page at different locations. For example, if the web page displays a 2-D map of a building, the users can be displayed at their respective virtual locations on the map. The display of the users can also encompass a 3-D or higher dimensional virtual representation of the location of the users. For example, the web page could represent a 3-D map with the users 3-D virtual locations with respect to the map represented on the web page. The web page could also represent a 4-D space, where the users 4-D virtual locations with respect to the space are represented on the web page.

FIG. 1(b) illustrates a browser which displays the list of users in a separate pane from the web page of the browser. It should be appreciated that by providing the user representation in a separate pane from the display of the web page, there is no need to customize the web page itself to support the display of users. In other embodiments, however, the web page can be configured to allow 2-D or 3-D text or images of the listed users to be overlayed on the content of the web page.

In any event, referring again to FIG. 1(c), the system may also allow user 1 to communicate with one or more of the other users on the web page. In this regard, the first user can then select one or more other users to communicate with by sending a communication request to the other user (step 140). If the first user then receives an acknowledgment from the other user indicating that the other user wishes to communicate with the first user within a specified time (step 150), a communication link is initiated between the first user and the other user (step 160). If not, the first user is informed that the communication link has not been established with the other user (step 180). The communication link can be established through the browser or another program on the system. For example, voice communication between the user and other user could be implemented using the Jini network technology from Sun Microsystems, Inc. Moreover, other server-client programs may also be used over the communication link, such as FTP, TELNET, instant messaging, and various chat programs.

Since other users may enter and leave the page after the first user has entered the page, the user 1 or an internal event (e.g., a timer) may request an update (step 170) by sending a message from the browser to the tracking server. The method then moves to the checking step (step 120).

Alternatively, the target server 2 may automatically update the list of users. A number of schemes could be used to implement such an automatic update. For example, the target server could periodically query each web page in its database, and send and updated list of users to each user on the web page at that time. As an alternative, each time that the target server 2 receives notification (e.g. step 100) from an instance of a browser 1 that a new web page has been entered, the target server 2 could search its database for a web page containing the user of that browser (e.g., user 1), and notify all other users on that web page that user 1 is no longer on the web page. The target server 2 could then proceed to update the database in step 110 as described above to contain the current web page of the user who initiated the notification.

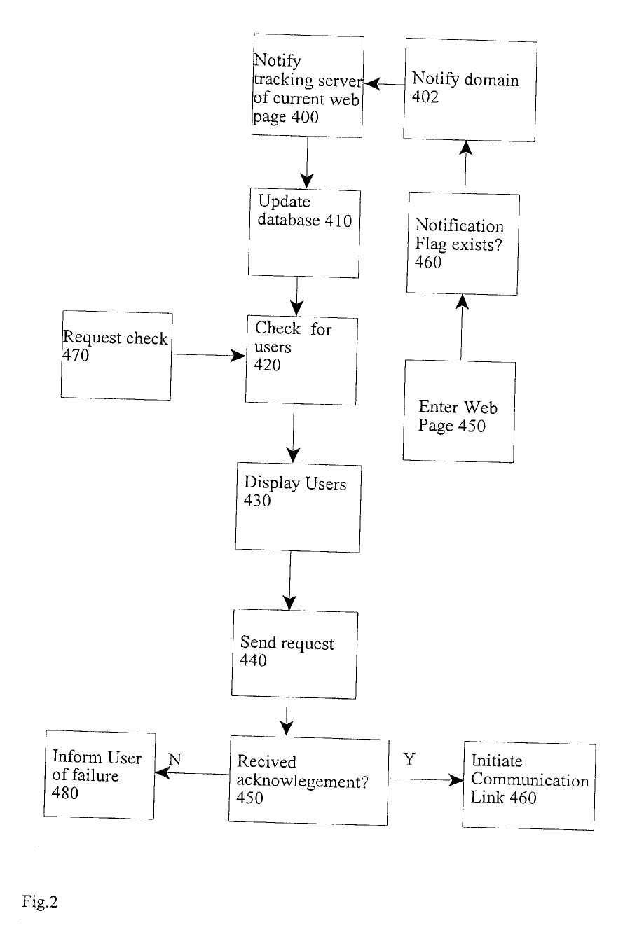

FIG. 2 shows a flow chart of a second embodiment of a web presence detector in accordance with the present invention. In accordance with this embodiment, when a browser, which user 1 directs, enters a web page (step 450), the browser notifies a domain of the web page (e.g., the web server 3) that user 1 has entered the web page (step 402). The domain, in turn, notifies the tracking server (step 400). The domain may query a central source and thereby obtain the address of the tracking server(s).

Similar to the embodiment of FIG. 1, the web page may include a notification flag which, in effect, allows the owner or administrator of the web page to “opt out” of the tracking function. In this regard, if the web page includes a notification flag (step 460), the browser notifies the domain of the web page that the browser has entered the web page (step 402). However, if there is no notification flag, the browser does not send a notification to the domain of the web page, and consequently, the domain of the web page does not notify the tracking server 2. The functionality implementing the notification flag checking step (step 460) when present, can be hard-coded into the browser 1.

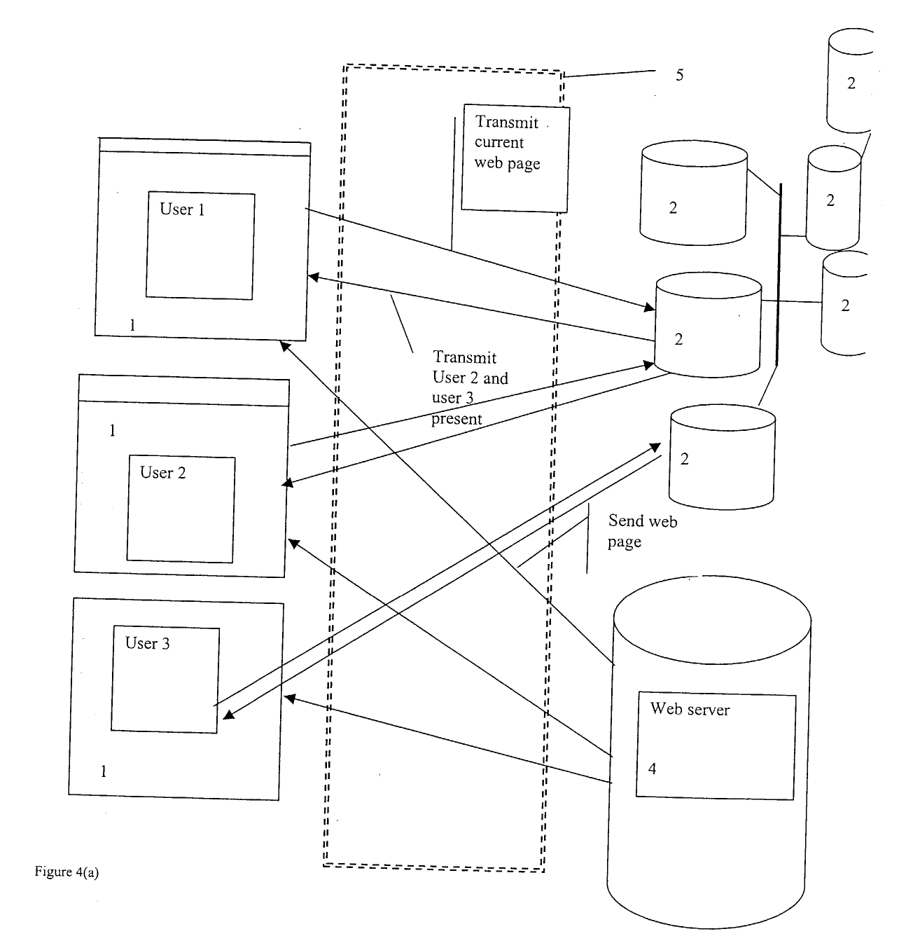

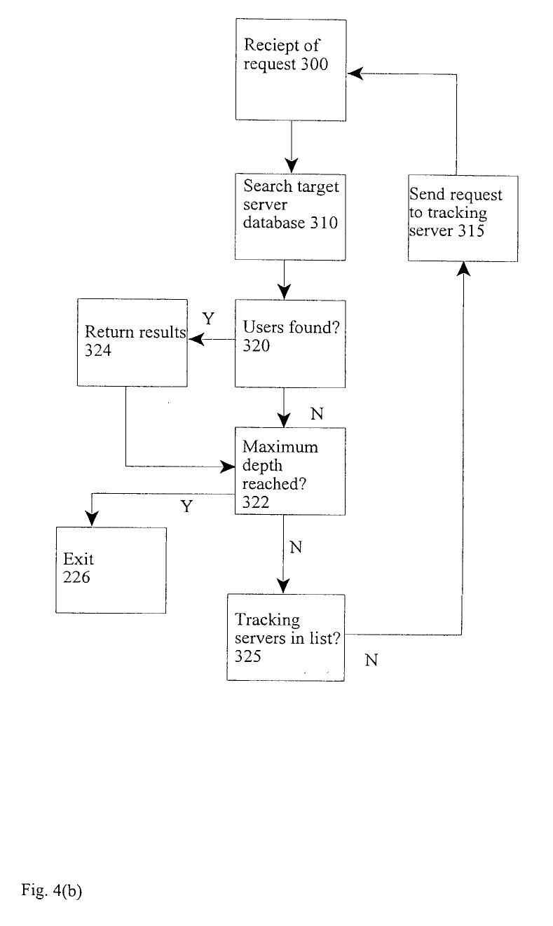

Once the tracking server 2 has been notified of the current web page of the user, the system proceeds in a manner similar to that of FIG. 1. Specifically, the tracking server 2 updates a database of which users are viewing which web pages (step 410), performs a check to determine if any users are currently viewing the web page (step 420), and then displays the users currently on the web page to user 1 (step 430) via the browser. As described above with regard to the embodiment of FIG. 1, the tracking server may maintain a log of prior web pages that the user (e.g., user 1) has visited, and step 430 may be performed by i) communicating from the tracking server to the browser, ii) communicating from the tracking server to the domain of the web page, and from the domain of the web page to the browser; or iii) communicating from the tracking server to the domain of the user, and from the domain of the user to the browser. The updated step 420 may simply involve querying the database associated with the tracking server for users in the current web page, or may involve more complicated schemes, which allow for more versatile network arrangements, as shown, for example, in FIGS. 3 and 4. The identified users on the web page can be displayed on the user's (e.g. user 1) browser in the manner described above with regard to FIG. 1, e.g., as text, icons, 2-D, 3-D, 4-D, and either in a separate pane or as an overlay over the web page itself. The display of users on the web page can be updated with an update request from the browser (step 470), or via automatic updates from the tracking server in the manner described above with regard to FIG. 1(a-c).

As described above with regard to FIG. 1, the user can then select one or more other users to communicate with by sending a communication request to the other user (step 440). If the user then receives an acknowledgment from the other user indicating that the other user wishes to communicate with the user within a specified time (step 450), a communication link is initiated between the user and the other user (step 460). If not, the user is informed that the communication link has not been established with the other user (step 480). The communication link can be established through the browser or another program on the system. For example, voice communication between the user and other user could be implemented by the Jini network technology. Moreover, other server-client programs may also be used over the communication link, such as FTP, TELNET, and various chat programs.

FIGS. 3(a) and 3(b) show an alternative system and method for determining if other users are currently viewing a web page (e.g., steps 120, 420). In accordance with this arrangement, a plurality of tracking servers 2 are arranged in a hierarchal structure, wherein each parent contains all the information of it's children (e.g., the tracking servers are arranged in a tree structure similar to a DNS tree).

Upon receiving a request from a user 1 to perform a check of a web page for users (step 200), a current tracking server searches the database associated with the tracking sever (step 210). If users are found (step 220), the results are returned for display in the browser (step 224). The results can be sent directly to the browser of user 1, the domain of the web page, or the domain of user 1 as described above. The results may also be sent to the tracking server of user 1 (e.g., the tracking server which received the notification 100, 400) and then on to the browser of user 1. The method then determines whether the current tracking server has a parent (step 205). If not, the method terminates (step 226). If the current tracking server has a parent, then a search request is sent to the parent (step 215), making the parent the current tracking server, and the process is repeated.

In order to limit the search time, the method may utilize a depth counter. Referring to FIG. 3, a depth counter is incremented (or decremented) each time a target server is searched. Then, in step 322, the method determines whether the maximum depth has been reached, and if it has, the method terminates (step 226). If the maximum depth has not been reached, the method proceeds to search any existing parent of the current tracking server.

The tracking servers can be located on different domains. Preferably, the request to perform a check contains the address of the browser of the first user, so that any tracking server can send the results of the search directly to the browser.

FIGS. 4(a) and 4(b) show an alternative system and method for searching for users on a web page (e.g., steps 120, 420). In accordance with this method, a plurality of tracking servers are arranged as a graph, wherein each tracking server is connected to at least one other tracking server (e.g., the tracking servers are arranged in a distributive network).

On receiving a request to perform a check of a web page for users (step 300) from a user 1, the system searches the database associated with the tracking server (step 310). If users are found (step 320), the results are returned for display in the browser (step 324). The results can be sent directly to the browser of user 1, the domain of user 1, or the domain of the web page as described above. The results may also be sent to the tracking server of user 1 and then on to user 1. The method then determines whether there are other tracking servers connected to the current tracking server on the graph which have not yet been searched (step 325). If not, the method terminates (step 226). If other unsearched servers 2 exist that are connected to the current tracking server 2, then a search request is sent to each other tracking server which connects to the tracking server on the graph (step 315). Each other tracking server then receives the request (step 300), and the process is repeated.

The request may contain a list of tracking servers already searched. Thus, the method may compare the list to the other tracking servers connected to the tracking server (step 325). The tracking server then sends the request (step 315) to only those tracking servers that are not in the list.

In order to limit the search time, the method may utilize a depth counter. Referring to FIG. 4, a depth counter is incremented (or decremented) each time a target server is searched. Then, in step 322, the method determines whether the maximum depth has been reached, and if it has, the method terminates (step 226). If the maximum depth has not been reached, the method proceeds to step 324 as discussed above.

The tracking servers can be located on different domains. Preferably, the request to perform a check contains the address of the browser of the first user, so that any tracking server can send the results of the search directly to the browser of user 1.

Although the present invention is preferably used to detect presences on a web page, it can be used to detect presences on other virtual locations, including, for example, non-web page addresses on LANs or WANs.

In the preceding specification, the invention has been described with reference to specific exemplary embodiments thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. A method for detecting one or more user presences in a virtual location including the steps of:
directing a web browser to enter a virtual location, the browser associated with a first user;
communicating the virtual location of the first user from the browser to a tracking server;
entering the first user and the virtual location of the first user, as a first user presence, into a database of user presences, the database associated with the tracking server;
searching the database for any user presences in the virtual location of the first user;
transmitting the user presences to the browser of the first user; and
communicating the user presences to the first user through the browser.

2. The method of claim 1, wherein the virtual location is a web page.

3. The method of claim 1, further comprising the steps of
directing the browser to enter a new virtual location
communicating the new virtual location of the first user from the browser to a tracking server;
removing the first user presence from the virtual location;
entering the first user and the new virtual location of the first user, as a new first user presence, into the database of the user presences;
searching the database for any user presences in the new virtual location of the first user;
transmitting the user presences to the browser of the first user;
communicating the user presences to the first user through the browser;
searching the database for any user presences in the virtual location;
transmitting the user presences in the virtual location to each browser associated with each of the user presences in the virtual location;
in each browser associated with each of the user presences in the virtual location, communicating the user presences to a respective user of said browser.

4. A system for identifying user presences in a virtual location, comprising:
a tracking server;
a plurality of web browsers executing on a plurality of processors, each browser, upon entering a virtual location, communicating the virtual location to the tracking server; and
the tracking server being configured to receive a virtual location from a respective one of the browsers, and to enter the a user of the respective one of the browsers and the virtual location into a database of user presences, the tracking server being configured to search the database for any user presences in the virtual location, and to communicate the user presences to the respective one of the browsers.

5. A system for identifying user presences in a virtual location, the system including:
a database, the database associating each of a plurality of users with a corresponding current virtual location displayed on a corresponding web browser of said each user;
a tracking server coupled to the database, the tracking server being configured to receive a new virtual location from a respective first browser of the plurality of browsers, and to associate a respective first user of the first browser with the new virtual location in the database, the tracking server being configured to search the database for any other ones of the plurality of users that are associated with the new virtual location, and to communicate the associated users to the first browser.

6. A system for identifying user presences in a virtual location, the system including:
a web browser, the browser configured to send, to a tracking server, a virtual location of a first user of a plurality of users, to receive, from the tracking server, an identification of any other user of the plurality of users that are associated with the virtual location, and to communicate the associated users to the first user.

7. The method as recited in claim 3 further comprising the step of setting a flag associated with the virtual location; and wherein the step of communicating the virtual location of the first user to the browser is not performed when the flag is set.

8. The method as recited in claim 1 wherein the tracking server includes a plurality of tracking servers arranged in a hierarchal network; and wherein the communication step includes communicating the virtual location to a first server of the plurality of tracking servers.

9. The method as recited in claim 1 wherein the tracking server includes a plurality of tracking servers arranged in a distributive network; and wherein the communication step includes communicating the virtual location to a first server of the plurality of tracking servers.

10. The method as recited in claim 8 wherein the database includes a plurality of databases, each database associated with a respective one of the tracking servers; and wherein the method further comprises the steps of querying at least one of the other tracking servers for any user presences in the virtual location of the first user and searching the database associated with the at least one of the other tracking severs for any user presences in the virtual location of the first user.

11. The method as recited in claim 9 wherein the database includes a plurality of databases, each database associated with a respective one of the tracking servers; and wherein, the method further comprises the steps of querying at least one of the other tracking servers for any user presences in the virtual location of the first user and searching the database associated with the at least one of the other tracking servers for any user presences in the virtual location of the first user.

12. The method as recited in claim 10 wherein the step of querying halts when a depth specified by a depth counter had been reached.

13. The method as recited in claim 11 wherein the step of querying halts when a depth specified by a depth counter had been reached.

14. The method as recited in claim 3 further comprising the step of forming from each virtual location a log of virtual locations of the first user.

15. The method as recited in claim 3 further comprising displaying a representation of the user presences in a representation of the virtual location to the respective user of said browser.

16. The method as recited in claim 3 further comprising establishing a communication link between the user presences and the respective user of said browser.

17. Computer readable media, having stored thereon, computer executable process steps operable to control a computer to:
receive a virtual location of a first user from a web browser;
enter the first user and the virtual location of the first user, as a first user presence, into a database of user presences; and
search the database for any user presences in the virtual location of the first user; and
transmit the user presences to the browser of the first user.

18. The computer readable media of claim 17, wherein the virtual location is a web page.

19. The computer readable media of claim 17, wherein the process steps are operable to control a computer to:
receive a new virtual location of the first user from the browser of the first user;
remove the first user presence from the virtual location;
enter the first user and the new virtual location of the first user, as a new first user presence, into the database of the user presences;
search the database for any user presences in the new virtual location of the first user;
transmit the user presences to the browser of the first user;
search the database for any user presences in the virtual location;
transmit the user presences in the virtual location to each browser associated with each of the user presences in the virtual location.

20. A system for identifying user presences in a virtual location, comprising:
a plurality of tracking servers arranged in a network, each tracking server having associated therewith a database of user presences;
a plurality of web browsers executing on a plurality of processors, each browser, upon entering a virtual location, communicating the virtual location to a first server of the plurality of tracking servers; and
the first tracking server being configured to receive a virtual location from a respective one of the browsers, and to enter a user of the respective one of the browsers and the virtual location into the database of user presences associated with the first tracking server, the first tracking server being configured to search the associated database to identify any user presences in the virtual location, the first tracking server being configured to query at least one of the other tracking server of the plurality tracking servers for any user presences in the virtual location of the first user;
each of the at least one of the other tracking servers being configured to search the database associated with the at least one of the other tracking servers to identify any user presences in the virtual location of the first user;
at least one of the first tracking server and the at least one of the other tracking servers being configured to communicate the identified user presences to the user via the respective one of the browsers.

21. The system of claim 20, wherein the network is a hierarchal network.

22. The system of claim 20, wherein the network is a distributed network.

23. The method of claim 1, wherein the communicating step further comprises communicating the user presences from the tracking server to a web server hosting the virtual location, and communicating the user presences from the web server to the first user through the browser.

24. The method of claim 1, wherein the communicating step further comprises communicating the user presences from the tracking server to a domain of the first user, and communicating the user presences from the domain of the first user to the first user through the browser.

25. The system of claim 4, wherein the tracking server is configured to communicate the user presences to the respective one of the browsers by communicating the user presences from the tracking server to a web server hosting the virtual location, and communicating the user presences from the domain of the respective one of the browsers to the respective one of the browsers.

26. The system of claim 4, wherein the tracking server is configured to communicate the user presences to the respective one of the browsers by communicating the user presences from the tracking server to a domain of the respective one of the browsers, and communicating the user presences from the domain of the respective one of the browsers to the respective one of the browsers.

27. The system of claim 5, wherein the tracking server is configured to communicate the associated users to the first browser by communicating the associated users from the tracking server to a web server hosting the virtual location, and communicating the associated users from the web server to the first browser.

28. The system of claim 5, wherein the tracking server is configured to communicate the associated users to the first browser by communicating the associated users from the tracking server to a domain of the first browser, and communicating the associated users from the domain of the first browser to the first browser.
